(19) United States
(12) Patent Application Publication
(10) Pub. No.: US 2010/0033341 A1
(43) Pub. Date: Feb. 11, 2010

(54) OPERATION SYSTEM AND OPERATION INSTRUCTION METHOD IN OPERATION SYSTEM

(75) Inventors: Masato Ishida, Kyoto (JP); Kenichi Kobayashi, Kyoto (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: MURATA KIKAI KABUSHIKI KAISHA, Kyoto-shi, Kyoto (JP)

(21) Appl. No.: 11/996,896

(22) PCT Filed: Jul. 3, 2006
(86) PCT No.: PCT/JP2006/313209

§ 371 Date: Jan. 25, 2008

(30) Foreign Application Priority Data
Jul. 27, 2005 (JP) 2005-217070

(51) Int. Cl. G08B 5/22

(52) U.S. Cl. 340/825.49; 348/159; 340/10.1

(57) ABSTRACT

An optical ID having a pair of light emitting sections (21, 22) is provided on a head set (18) which is mounted on the head of an operator, and ID data is transmitted by a light emitting signal. A high-speed camera is provided on a ceiling of a pathway, the ID data and the position of the operator are identified by the light emitting signal, and the direction of the operator is obtained by the direction of the pair of light emitting sections.

### TECHNICAL FIELD

The present invention relates to a system in which an operator works in a predetermined area, e.g., uses a cart or the like, and moves along a pathway between racks for picking articles. In particular, the present invention relates to a technique of recognizing ID data, a position, and a direction of an operator, and providing an operation instruction to the operator.

### BACKGROUND ART

When ID data, a position, and a direction of an operator in a picking area are found, it is possible to provide an operation instruction, e.g., for guiding the operator to the next picking position. In particular, at an intersection between pathways of the picking area, in order to detect any error, e.g., the case where the operator turned right erroneously, though the operator should have moved straight forward, it is not sufficient to roughly determine the orientation (e.g., forward movement or backward movement), and it is necessary to determine the correct orientation, i.e., direction.

In a possible approach, in order to recognize the orientation of the operator, for example, the position of the operator is tracked all the time, and the orientation is determined based on the change in the position of the operator. However, in this approach, assuming that the operator turned right erroneously, though the operator should have moved forward straight, it is not possible to detect the error before the operator actually turns to the right. Further, assuming that the operator turned toward the right rack, though the operator is supposed to pick an article from the left rack, it is not possible to detect the error before the operator actually moves to a position near the right rack. As described above, in the approach of determining the orientation based on the change in the position, the detection is too late. Patent Publication 1 (Japanese Patent No. 2528417) discloses a technique of determining whether an operation cart is oriented forward or backward using ID data tags and tag readers. However, in the technique, it is not possible to detect further detailed orientation such as the right forward orientation or the left backward orientation. Further, in order to recognize the ID of the operator, dedicated means used for this purpose is required additionally.

### DISCLOSURE OF THE INVENTION

### Problems to be solved by the Invention

An object of the present invention is to determine ID data, a position, and a direction of an operator with simple structure for making it possible to provide suitable operation instruction.

Another object of the present invention is to make it possible to accurately determine a direction of an operator.

Still another object of the present invention is to provide an operation instruction to an operator in a manner that the operator can understand the operation instruction easily.

### Means for Solving the Problems

The present invention relates to a system for providing an operation instruction from a controller to an operator. The operation system includes an optical ID having at least a pair of light emitting sections for outputting ID data by a light emission signal from the light emitting sections. The optical ID moves together with the operator. Further, the operation system includes a plurality of cameras arranged along a pathway of the operator, for determining the ID data, a position of the optical ID, and a direction of the pair of light emission sections by receiving the light emission signal from the optical ID. The system is characterized in that an ID, a position, and a direction of the operator are identified based on a signal from the cameras for allowing the controller to output the operation instruction to the operator.

Preferably, the optical ID is attached to a headset worn on a head of the operator.

Further, preferably, the headset further includes wireless communication means for reporting an operation result to the controller, and receiving the operation instruction from the controller.

Particularly preferably, the operation system further includes a monocle display for displaying the operation instruction from the controller to the operator.

Preferably, the operation system includes an RFID reader carried by the operator, for reading an RFID of an article handled by the operator to report the RFID read by the RFID reader from the wireless communication means to the controller.

Further, preferably, the operation system further includes a bulletin panel provided in the pathway for the operator, and indicating the operation instruction, an RFID reader carried by the operator, for reading an RFID of an article handled by the operator, and a portable communication device for transmitting the RFID read by the RFID reader to the controller.

Further, the present invention relates to a method of providing an operation instruction from a controller to an operator, and the method includes the steps of providing an optical ID having at least a pair of light emitting sections for outputting ID data by a light emission signal from the light emitting sections; arranging a plurality of cameras along a pathway of an operator, for determining the ID data, a position of the optical ID, and a direction of the pair of light emission sections by receiving the light emission signal from the optical ID; moving the optical ID together with the operator; and identifying an ID, a position, and a direction of the operator based on a signal from the cameras, and providing the operation instruction to the operator by the controller.

The wavelength used by the optical ID is a wavelength of an infrared light or a visible light. In particular, the visible light is preferable. Further, the ID data of the optical ID itself and the ID data of the operator are regarded as the same. The optical ID may be carried by the operator. Alternatively, the optical ID may be attached to a cart or the like.

### ADVANTAGES OF THE INVENTION

In the present invention, in addition to the ID data of the operator, the position and the direction of the operator can be determined based on the optical ID. Thus, it is possible to provide a suitable operation instruction in accordance with the position of each operator.

In the present invention, preferably, the optical ID is set on the head of the operator. Therefore, it is possible to accurately determine the direction of the operator. Further, since the optical ID is attached to the headset, the operator can wear the headset easily. Further, the headset is not likely to be hidden by other objects. Therefore, the headset is normally visible.

In the present invention, preferably, the operation result is reported from the headset to the controller, and the controller receives the operating instruction. Thus, at the headset, it is possible to detect the ID, the position, and the direction of the operator, and receive and send the operation result and instruction.

In the present invention, preferably, the operation instruction is displayed on the monocle display. Therefore, without looking at the display of a portable terminal or an operation cart, it is possible to view the operation instruction all the time. Further, in the case where the ID of the article handled by the operator is read by the RFID reader carried by the operator, and the read ID is transmitted from the wireless communication means of the headset to the controller, it is possible to report the ID to the controller without requiring the operator to input the detailed information of the article handled by the operator. The ID of the article may be attached to the article itself. Alternatively, the ID of the article may be attached to a container, a rack or the like where the article is stored.

In the case where the operator reads the ID of the article handled by the operator using the RFID reader held by the operator, the read RFID is transmitted from the portable communication device to the controller, and the controller displays the operation instruction on the bulletin panel in the pathway, it is possible to report the operation result and provide the operation instruction at economically.

### BRIEF DESCRIPTION OF THE DRAWINGS

FIG. 1 is a plan view showing a layout of a picking system according to an embodiment.

FIG. 2 is a view schematically showing an operator equipped with a headset, an RFID reader-writer, and a cellular phone.

FIG. 3 is a block diagram showing a headset and an RF-reader-writer on an operator side, and a camera terminal on a controller side.

FIG. 4 is a block diagram showing a picking system according to a modified embodiment.

### DESCRIPTION OF THE NUMERALS

2: picking system
4: rack
6: pathway
8: intersection
10, 11: camera terminal
12: controller
14: operator
16: cart
18: headset
20: headset body
21, 22: LED
23: wearable display
24: antenna
30: RFID reader-writer
32: band
34: reader-writer body
36: reader-writer head
38: cellular phone
40, 43: power supply
41: light emission data output unit
42: light emission control unit
44: wireless communication unit
45: transmission processing unit
46: reception processing unit
50: fisheye lens
51: high speed camera
52: position recognition unit
53: data detection unit
54: wireless communication unit
55: antenna
56: communication unit
60: headset
62: high speed camera
64: bulletin panel

### BEST MODE FOR CARRYING OUT THE INVENTION

Hereinafter, an embodiment in the most preferred form for carrying out the present invention will be described.

### EMBODIMENTS

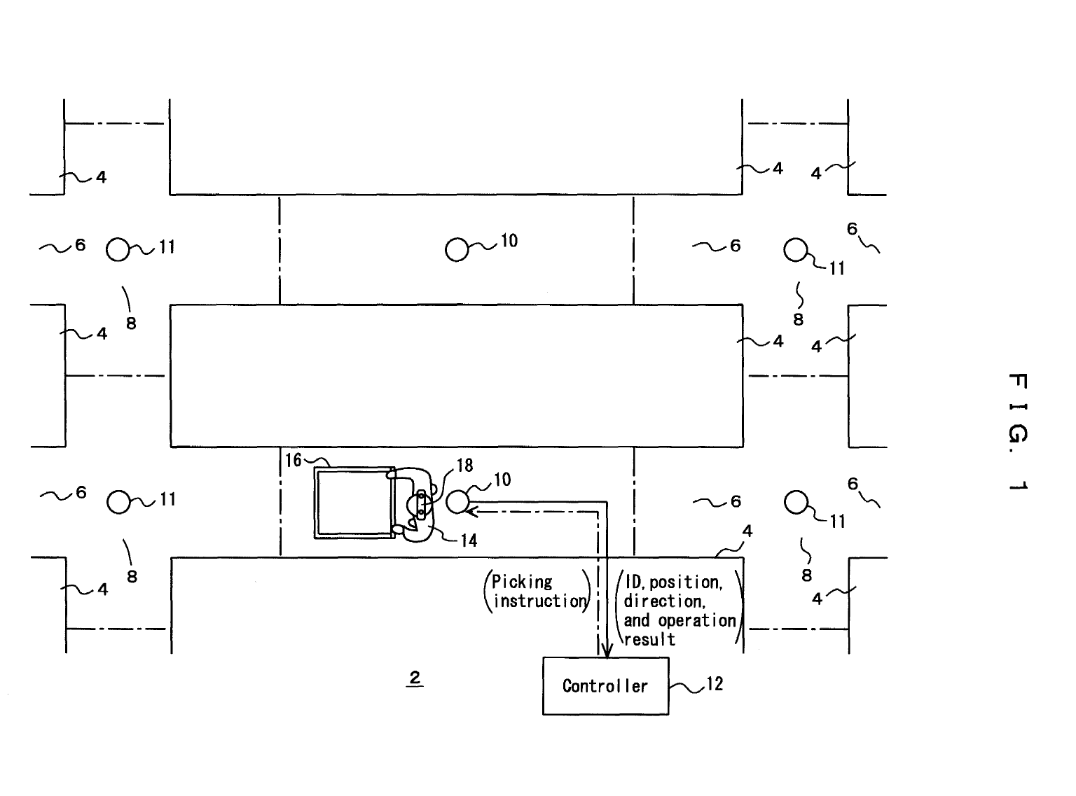

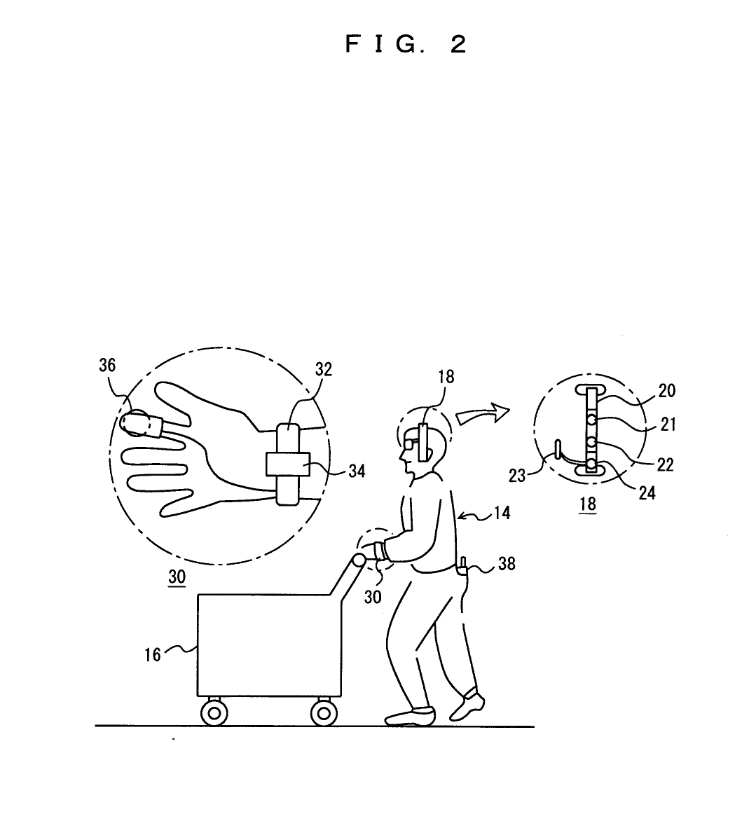

FIGS. 1 to 4 show a picking system 2 according to an embodiment and its modified embodiment. Racks 4 and pathways 6 are provided in a picking area. Reference numerals 8 denote intersections. Camera terminals 10, 11 are provided in the pathways 6, the intersections 8 or the like. For example, wide-angle lens and fisheye lens are provided for the camera terminals 10, 11 for making it possible to detect optical IDs in wide ranges. The camera terminal 10 provided in the pathway 6 needs to have a straight viewing field. Therefore, the wide-angle lens or the fisheye lens in front of the camera terminal 10 is configured to have the straight viewing field. The camera terminal 11 provided at the intersection 8 needs to have a planar viewing field. Therefore, in the same manner, the wide-angle lens or the fisheye lens for the camera terminal 11 is configured to have the planar viewing field. Hereinafter, it is assumed that fisheye lenses are used for the camera terminals 10, 11. Wide-angle lenses or normal lenses may be used for the camera terminals 10, 11.

A reference numeral 12 denotes a controller for controlling the overall operation in the picking system 2. The ID data, the position, and the direction of the operator, and the operation result are inputted from the camera terminals 10, 11 to the controller 12. In response to these items of data, the controller 12 outputs an instruction for picking operation on a wearable display worn by the operator. In practice, the ID data of the operator is ID data of an optical ID attached to the headset. That is, the ID data of the optical ID is regarded as identical to the ID data of the operator. As described later, the operation result may be transmitted from, e.g., a cellular phone carried by the operator or a portable terminal attached to a cart 16 or the like, to the controller 12. Likewise, the instruction of picking may be outputted to the cellular phone or the portable terminal attached to the cart 16. A reference numeral 14 denotes an operator who performs picking operation. A plurality of operators may perform such operations in the picking area. The reference numeral 16 denotes the cart, and the cart 16 may be a hand cart. Alternatively, the cart 16 may have a motor. A reference numeral 18 denotes the headset, and the optical ID is attached to the headset 18. The headset 18 is worn on the head of the operator.

The headset 18 has a headset body 20 attached to the head of the operator. For example, a pair of LEDs 21, 22 are provided at upper positions of the headset body 20. Further, the wearable display 23 is attached to the headset body 20 for allowing the operator 14 to view the wearable display 23 of a monocle type. For example, the wearable display 23 is a liquid crystal display having roughly a glass lens size. A reference numeral 24 denotes an antenna for carrying out wireless communication with the camera terminals 10, 11, or the like.

A reference numeral 30 denotes an RFID reader-writer for reading data from an RFID data tag attached to each of picked articles, and writing ID data of the operator in the tag, to obtain data of the result of the picking operation. In the embodiment, it is assumed that the RFID reader-writer 30 is attached to the wrist like a wristwatch. A reference numeral 32 denotes a band, and a reference numeral 34 denotes a reader-writer body. Each time an article is picked, a reader-writer head 36 is attached to a fingertip for reading, and writing ID data for the article. Further, the operator has a cellular phone 38 for carrying out data communication with the controller 12.

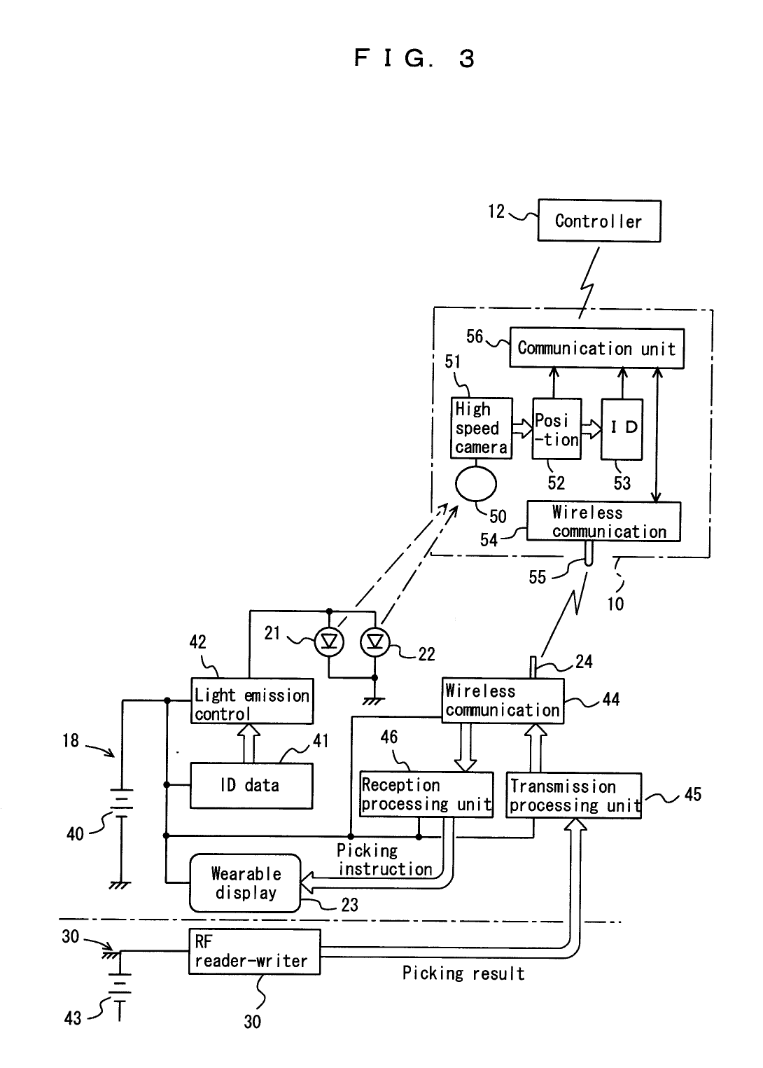

In FIG. 3, a reference numeral 40 denotes a power supply provided for the headset 18. A reference numeral 43 denotes a power supply for the RFID reader-writer 30. On the optical ID side, the ID data is outputted from a light emission data output unit 41 to a light emission control unit 42 for controlling light emission from the LEDs 21, 22 to output the ID data. Preferably, the LEDs 21, 22 use different light emission wavelengths or light emission patterns so that the LEDs 21, 22 can be distinguished from each other by the camera terminals 10, 11. In this manner, for example, it is possible to easily identify whether the operator is moving forward or moving backward. When picking is performed using the RFID reader-writer 30, for example, data of the picking result is transmitted to the headset 18 through an unillustrated line, and the data of the picking result is transmitted from the antenna 24 of the wireless communication unit 44 to the antenna 55 of the wireless communication unit 54.

Each of the camera terminals 10, 11 uses the fisheye lens 50 or the wide angle lens for making it possible to detect light emission from the LEDs 21, 22 in a wide viewing field. After the light passes through the fisheye lens 50, the light is imaged by a high speed camera 51. For example, using a CCD camera, imaging is performed 1000 times per second. In the case where the light emission signals from the LEDs 21, 22 have a frequency lower than the imaging frequency of the camera, e.g., about 100 Hz, it is possible to recognize the ON/OFF patterns of the LEDs 21, 22 by the high speed camera 51. A position recognition unit 52 detects positions of bright points of the LEDs 21, 22 in the viewing field of the high speed camera 51, and determines the position of the operator based on the detected positions of the LEDs 21, 22. At this time, by using different light emission wavelengths, or different light emission patterns for the LEDs 21, 22, it is possible to distinguish the LED 21, 22 from each other. Thus, the position recognition unit 52 can detect the orientation of the headset 18 e.g., with the resolution of about 10°. A data detection unit 53 reads the ID data of the optical ID based on the change in the light-dark condition at the position determined by the position recognition unit 52. Accordingly, the position, the direction, and the ID data of the operator are determined. These items of the data are transmitted to the controller 12 through a communication unit 56.

The controller 12 outputs a picking instruction to the operator based on data such as the ID data, the position, and the direction of the operator, and the picking result transmitted from the wireless communication unit 44. The instruction is transmitted from the antenna 55 of the wireless communication unit 54 to a reception processing unit 46 though the antenna 24 of the headset, and displayed on the wearable display 23.

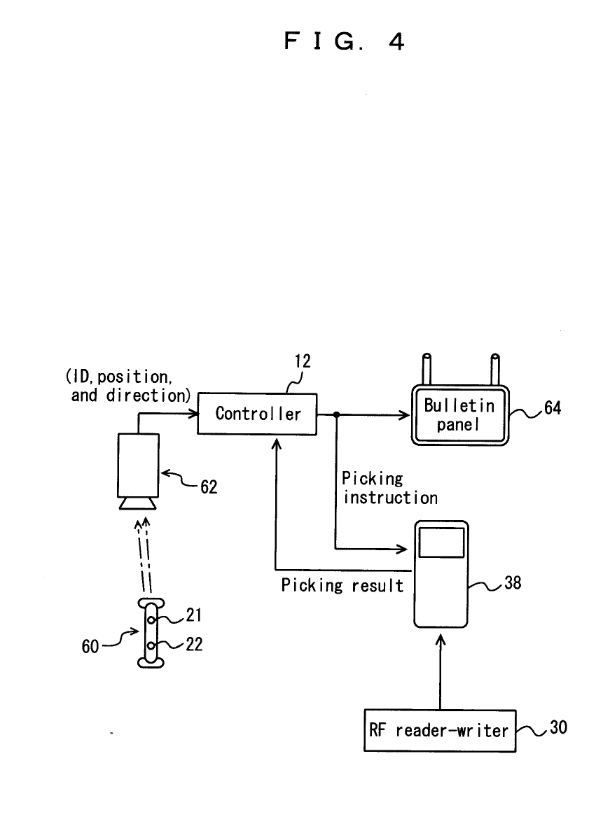

FIG. 4 shows a picking system according to a modified embodiment. In the modified embodiment, the headset 18 is simplified by eliminating components such as the wireless communication unit 44 in FIG. 3, except the optical ID comprising the pair of LEDs 21, 22. Further, in the modified embodiment, the operation instruction is not displayed on the wearable display 23. The operation instruction is provided on a display panel of the cellular phone 38 or a cart, or on a bulletin panel of a plasma display or a liquid crystal display provided in an intersection or a pathway of the picking area. On the high speed camera 62 side, components such as the wireless communication unit 54 in FIG. 3 is eliminated, and only the ID data, the position, and the direction are detected. The controller 12 outputs a picking instruction to the bulletin panel 64, the cellular phone 38, or a panel provided in a cart. The other features are the same as those of the embodiment shown in FIGS. 1 to 3. Further, the optical ID may be provided in a cart or a forklift instead of the headsets 18, 60.

In the embodiment and the modified embodiment, the following advantages are obtained.

(1) It is possible to determine the ID data, the position, and the direction of the operator. In particular, in the case where the optical ID is provided in the headset, it is possible to swiftly, and accurately recognize the operator's movement, e.g., recognize that the operator is oriented to the right side or left side of the pathway, or the operator is making a right turn. Thus, when the moving direction of the operator is wrong, or the picking position is wrong, it is possible to immediately provide a suitable instruction on the wearable display.
(2) In the case where the operating instruction is displayed on the wearable display, it is not necessary to take out the portable terminal, or look at the panel provided in the cart or the forklift, or the bulletin board. It is possible to view the picking instruction on the wearable display all the time for movement within the picking area to perform picking operation.
(3) Since the ID data of the picked article can be read, or written by the reader-writer head 36 attached to, e.g., a fingertip, no confusion of data with the other ID data occurs. The read ID data or the like can be inputted from the wireless communication unit 44 of the headset to the controller through the high speed camera.
(4) In the case where the fisheye lenses or the wide angle lenses are used for the camera terminals 10, 11, it is possible to cover the entire picking area by a small number of cameras.

In the embodiments, the picking system where picking is performed by the operator is taken as an example. The present invention is also applicable to an operation system where loading and unloading operations are carried out by a forklift. In this case, the optical ID is attached to the ceiling of the forklift instead of the headsets 18, 60. Further, as the display, instead of the wearable display 23, a display screen provided in the forklift may be used.

1. A system for providing an individual operation instruction from a controller to operators working in an operation area,
the system including:
an optical ID provided for each of the operators, the optical ID having at least a pair of light emitting sections for outputting individual ID data of an individual operator by a light emission signal from the light emitting sections, the optical ID moving together with the individual operator; and
a plurality of cameras arranged along a pathway of the operators in the operation area, for determining the ID data, a position of the optical ID, and a direction of the pair of light emission sections by receiving the light emission signal from the optical ID, wherein
the ID data, the position, and the direction of the individual operator are identified based on a signal from the cameras for allowing the controller to output the operation instruction to the individual operator based on the identified ID data, the position, and the direction of the individual operator.

2. The operation system according to claim 1, wherein the optical ID is attached to a headset worn on a head of the individual operator.

3. The operation system according to claim 2, wherein the headset further includes radio communication means for reporting an operation result of the individual operator from the headset to the controller, and the controller outputs the operation instruction to the headset based on the ID data and the direction of the operator and the reported operation result.

4. The operation system according to claim 3, further including a monocle display for displaying the operation instruction from the controller to the operator.

5. The operation system according to claim 3, further including an RFID reader carried by the operator, for reading RFIDs of articles handled by the operator to report the RFIDs read by the RFID reader from the radio communication means to the controller.

6. The operation system according to claim 1, further including:
a bulletin panel indicating the operation instruction, the bulletin panel being provided in the pathway for the operators;
an RFID reader carried by the operator, for reading RFIDs of articles handled by the operator; and
a portable communication device for transmitting the RFID read by the RFID reader to the controller.

7. A method of providing an individual operation instruction from a controller to operators working in an operation area, the method including the steps of:
providing an optical ID for each of the operators, the optical ID having at least a pair of light emitting sections for outputting individual ID data of an individual operator by a light emission signal from the light emitting sections;
arranging a plurality of cameras along a pathway of operators in the operation area, for determining the ID data, a position of the optical ID, and a direction of the pair of light emission sections by receiving the light emission signal from the optical ID;
moving the optical ID together with the individual operator; and
identifying the ID data, the position, and the direction of the individual operator based on a signal from the cameras, and providing the operation instruction to the individual operator by the controller based on the identified ID data, the position, and the direction of the individual operator.
